(19) United States
(12) Patent Application Publication
(10) Pub. No.: US 2009/0123013 A1
(43) Pub. Date: May 14, 2009

(54) Hearing aid device

(75) Inventor: Chee Wah Leong, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/291,174

(22) Filed: Nov. 6, 2008

(30) Foreign Application Priority Data
Nov. 14, 2007 (DE) 10 2007 054 325.7

(51) Int. Cl. H04R 25/00

(52) U.S. Cl. 381/324; 381/314; 381/330

(57) ABSTRACT

A hearing aid device is provided. The hearing aid includes a housing, electrical components arranged within the housing and an adjusting element. The adjustment element is provided to modify a setting value of at least one the electrical components. In one aspect, the adjusting element is operable in a contact-free fashion.

### CROSS REFERENCE TO RELATED APPLICATIONS

This application claims priority of German application No. 10 2007 054 325.7 DE filed Nov. 14, 2007, which is incorporated by reference herein in its entirety.

### FIELD OF INVENTION

The invention relates to a hearing aid device with a housing and electrical components arranged therein.

### BACKGROUND OF INVENTION

Hearing aid devices are used to compensate for hearing losses for the hard-of-hearing. So-called behind-the-ear devices are known, which consist of an otoplastic worn in the ear as well as a housing worn behind the ear, which contains the electrical components necessary in order to realize a hearing aid function. In-the-ear devices are also known, which only consist of a part worn in the ear, which contains the electrical components.

### SUMMARY OF INVENTION

Known hearing aid devices have keys, switches, slide controls and such like, with which the hearing aid device can be switched on and/or off, with which the volume of the hearing aid device can be changed and which are provided to adjust further setting values of the hearing aid device. One problem of such mechanical switching and adjustment elements is their proneness to faults and sensitivity to appearances of wear and tear and contamination.

The publication DE 196 33 321 A1 discloses a hearing aid device with an external actuating element for controlling an operating mode. The actuating element includes an operating lever, which has a magnet on its end and to which magnetic field a sensor element provided inside the housing of the hearing aid device responds. The sensor element is therefore activated in a contact-free fashion, the operating lever itself is however mechanically actuated.

The publication EP 0 548 379 B1 discloses a hearing aid device with a housing and electrical components arranged therein, such as a microphone, amplifier, receiver, current source, on/off switch and adjustment elements, with which the use of pressure and position sensors in a film design is provided. The pressure and position sensors consist of laminated polymer layers, with one layer being coated with interdigitated electrodes and the associated other layer being coated with a semiconductor material, with the sensors being arranged on the exterior and/or on the interior of the housing and/or in the housing wall and/or on a support positioned in the housing. The sensors react to contact or pressure with a variable electrical resistor. The sensors are embodied as switches and/or as controllers. They cannot be operated in a contact-free fashion. One disadvantage of this hearing aid device is likewise proneness to faults of the pressure and position sensors provided as adjusting, control or switching elements which increase as a result of wear and tear.

The object of the invention is to advantageously embody a hearing aid device of the type mentioned in the introduction in respect of the switching, adjusting and/or control elements according to design and operation such that user-friendly, durable, less error-prone and miniaturisable components are used.

This object is achieved by a hearing aid device according to the independent claims. Preferred developments are specified in the dependent claims.

The inventive hearing aid device has a housing with electrical components arranged therein and an adjustment element, which is provided in order to modify a setting value of the electrical components, with the adjusting element being operable in a contact-free fashion.

With the inventive hearing aid device, some or all mechanical adjusting elements are replaced by one or several contact-free adjusting elements. The user of the inventive hearing aid device can modify a setting of the hearing aid device by moving a finger or object closer to a contact-free adjusting element of the hearing aid device. For instance, the inventive hearing aid device can be switched on and/or off once by moving a finger or object closer to the adjusting element. In another embodiment, the inventive hearing aid device can be switched on and/or off for instance by moving a finger or object closer to the adjusting element for a second time within a predefined time. The user can also adjust the volume of the hearing aid device for instance, by running his/her finger over an adjusting element of the hearing aid device.

In a preferred embodiment of the inventive hearing aid device, the adjusting element is designed to make a distinction between a plurality of movement patterns of the contact-free detect finger or object and to change assigned setting values of the hearing aid device in each instance.

As the adjusting element of the inventive hearing aid device does without mechanical moveable components, it is insensitive to wear and tear appearances.

In an advantageous embodiment of the invention, one or several adjusting elements are provided within a housing of the hearing aid device. This allows the housing to be provided with a smooth, continuously closed surface. As a result, the hearing aid device can be designed to be more favorable and less conspicuous when worn by a user. The closed housing also enables the hearing aid device to be embodied in a manner impenetrable to splash water or water. As a result, its proneness to faults also reduces.

In a preferred embodiment of the inventive hearing aid device, the adjusting element is designed to detect the presence and/or position of an object or finger in the surroundings of the adjusting element by measuring an electrical capacity.

In a further preferred embodiment of the inventive hearing aid device, the adjusting element is designed to detect the presence and/or position of an object or finger in the surroundings of the adjusting element by measuring the reflected signal of an emitted measuring signal.

In a further preferred embodiment of the inventive hearing aid device, the adjusting element is designed to detect the presence and/or position of an object or finger in the surroundings of the adjusting element by measuring a heat radiation.

### BRIEF DESCRIPTION OF THE DRAWINGS

The invention is described in more detail below with reference to the exemplary embodiments illustrated in the drawings, in which:

FIG. 1 shows a hearing aid device embodied in accordance with the invention having an adjusting element 10, with the hearing aid device in the exemplary embodiment being designed as a hearing aid device to be worn behind the ear;

FIG. 2 shows a section through a housing 1 of an inventive hearing aid device with an adjusting element 10 attached within the housing and a finger 20 of the user which passes over the adjusting element 10;

FIG. 3 shows a section through a housing 1 of an inventive hearing aid device with an adjusting element 10 inserted into the housing wall and a finger 20 of the user passing over the adjusting element 10;

FIG. 4 shows a further schematic view of an inventive hearing aid device with a housing 1 and an adjusting element 10 attached therein by means of guide rails 12.

### DETAILED DESCRIPTION OF INVENTION

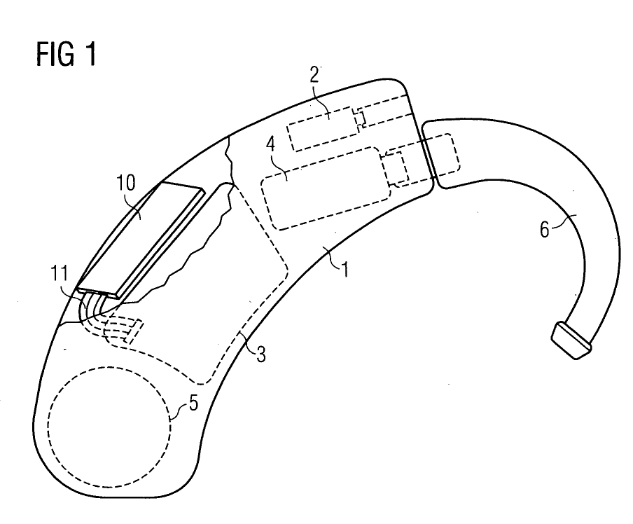

FIG. 1 shows a housing 1 of a hearing aid device to be worn behind the ear. A hearing aid function is realized within the housing 1. The realization of the hearing aid function can include electrical components like a microphone 2, an amplifier 3, a receiver 4 as well as a power source 5. The housing 1 has a wearing hook 6, which allows the housing 1 of the hearing aid device to be fixed behind the ear. The hearing aid device records ambient noises with the aid of the microphone 2, amplifies these by means of the amplifier 3 and forwards them by way of the receiver 4.

The housing 1 of the hearing aid device also has an adjusting element 10. The adjusting element 10 is arranged within the housing 1 parallel to a surface of the housing 1. The adjusting element 10 is connected to the amplifier 3 of the hearing aid function by way of a flexible cable 11.

By tapping the adjusting element 10 with a finger 20, the hearing aid device can be switched on or off. The evaluation electronics system of the adjusting element 10 interprets brief contact of the adjusting element 10 as the user's desire to switch the hearing aid device on and/or off. In an alternative embodiment, the evaluation electronics system of the adjusting element 10 interprets a second brief contact of the adjusting element 10 within a predefined time as the user's desire to switch the hearing aid device on and/or off.

The user of the hearing aid device can modify the set volume of the hearing aid device by passing his/her finger 20 over the surface of the adjusting element 10. The evaluation electronics system of the adjusting element 10 interprets a passing movement of the finger 20 in a first direction along the surface of the adjusting element 10 as a desire to increase the set volume of the hearing aid device. The evaluation electronics system of the adjusting element 10 interprets a passing movement of a finger 20 in a second direction along the surface of the adjusting element 10 as the user's desire to reduce the set volume of the hearing aid device.

The evaluation electronics system of the adjusting element 10 can be provided to identify additional movement patterns of a finger 20 on the surface of the adjusting element 10 as additional user's wishes and to adjust corresponding settings of the hearing aid device. The adjusting element 10 can be expediently embodied in the manner of points, stripes or laminar (as matrix).

The adjusting element 10 can implement a measurement of electrical capacities for instance, in order to determine the position of the finger 20 on the surface of the adjusting element 10. To this end, the adjusting element 10 can have electrodes arranged vertically or horizontally in the plane, which form a grid. The evaluation electronic system of the adjusting element 10 implements continuous measurements of the capacitances of these electrodes. A finger 20 positioned in the surroundings of the adjusting element 10 modifies the capacity of the electrodes. The evaluation electronics system of the adjusting element 10 can determine the position of the finger 20 on the surface of the adjusting element 10 from the pattern of the capacity modifications. A movement of the finger 20 can be identified by the evaluation electronics system of the adjusting element 10 from the time response of the capacity modifications.

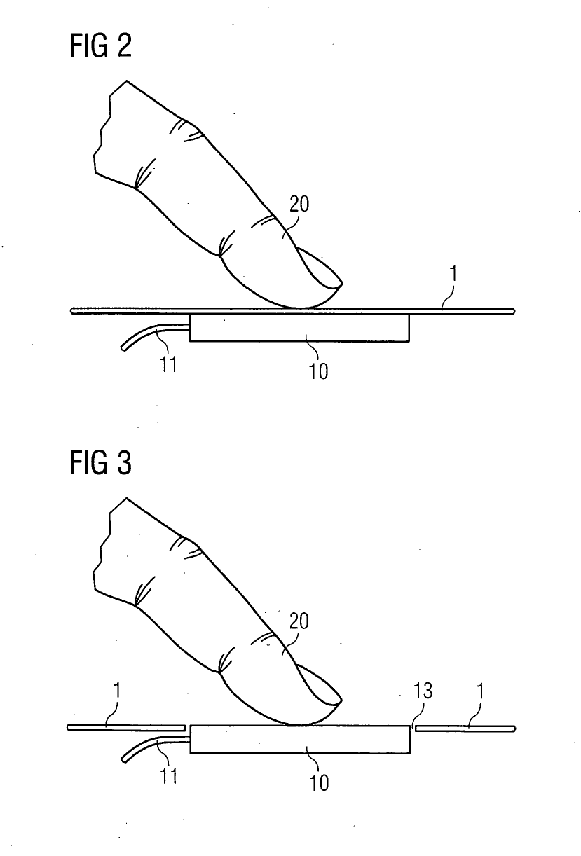

Due to the capacitive measuring methods, the finger 20 does not have to touch the adjusting element 10 directly. This allows the adjusting element 10 to be attached within the housing 1 of the hearing aid device, as shown in FIG. 2. The surface of the adjusting element 10 is arranged in parallel to the housing surface of the hearing aid device. The wall of the housing 1 across the adjusting element 10 is so thin that the adjusting element 10 is able to detect the position of a finger 20, which touches the housing 1 from outside above the adjusting element 10. The wall thickness of the housing 1 above the adjusting element 10 can amount to half a millimeter for instance. The housing wall can be thinner above the adjusting element 10 than in other sections of the housing 1.

The housing 1 of the hearing aid device is at least manufactured from a material in the region above the adjusting element 10, which allows a capacitive influence of the adjusting element 10 by a finger 20 touching the housing from outside. The housing 1 can be manufactured from plastic for instance. The housing wall can consist of a different material above the adjusting element 10 than in other sections of the housing 1.

In another embodiment of the inventive hearing aid device, the adjusting element 10 can determine the position of the finger 20 or other object in the surroundings of the adjusting element 10 by measuring the reflected signal of an emitted measuring signal. To this end, the adjusting element 10 can emit an electromagnetic signal like visible light, an infrared or radio frequency radiation or a sound, for instance ultrasound signal. The adjusting element 10 can determine the position of a finger 20 or other object in the surroundings of the hearing aid device from the phasing and/or the intensity of the reflected signal.

In another embodiment of the inventive hearing aid device, the adjusting element 10 can detect the position of the finger 20 or other object in the surroundings of the adjusting element 10 by measuring a heat radiation emitted by the finger 20 or other object. In this way, the wall of the housing 1 can consist of material which is permeable to heat radiation above the adjusting element 10.

As the adjusting element 10 is arranged within the housing 1 of the hearing aid device, the housing 1 can be embodied to be completely closed. As a result, the penetration of dirt and water into the housing 1 is prevented and the proneness of the hearing aid device to faults is reduced. In a preferred embodiment, the housing 1 of the hearing aid device can be embodied so as to be impermeable to splash water or completely watertight. The adjusting element 10 has no moveable mechanical components and is thus insensitive to wear and tear appearance. The closed housing 1 of the hearing aid device allows an attractive and inconspicuous design of the hearing aid device.

FIG. 3 shows a schematic representation of an alternative embodiment of an inventive hearing aid device. In this embodiment, the adjusting element 10 is arranged in a recess 13 of the housing 1. As a result, the surface of the adjusting element 10 is accessible from the outside. The adjusting element 10 is preferably inserted flush in the recess 13, so that the surface of the adjusting element 10 forms a smooth surface with the wall of the housing 1.

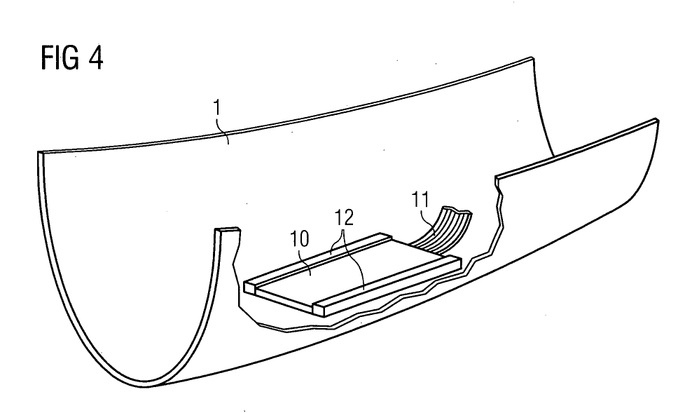

FIG. 4 shows a further schematic view of a section of a housing 1 of an inventive hearing aid device. An interior view of the housing 1 is shown. An adjusting element 10 is arranged on the inside of the housing 1 like in FIG. 2. The adjusting element 10 is held against the wall of the housing 1 by two guide rails 12. The adjusting element 10 is connected to an amplifier 3 of the hearing aid device by way of a flexible cable 11.

1-16. (canceled)

17. A hearing aid device, comprising:
a housing;
a plurality electrical components arranged within the housing; and
an adjusting element that modify a setting value of at least one of the electrical components, the adjusting element is a non-mechanical control element.

18. The hearing aid device as claimed in claim 17, wherein the adjusting element is be operable in a contact-free fashion.

19. The hearing aid device as claimed in claim 17, wherein the adjusting element forms a part of the wall of the housing.

20. The hearing aid device as claimed in claim 17, wherein the adjusting element is arranged within the housing.

21. The hearing aid device as claimed in claim 20, wherein a wall thickness of the housing above the adjusting element is less than a wall thickness in other housing sections.

22. The hearing aid device as claimed in claim 20, wherein the housing wall above the adjusting element includes insulating material.

23. The hearing aid device as claimed in claim 17, wherein the adjusting element detects the presence and/or position of an object or finger in the surroundings of the adjusting element by measuring the electrical capacity.

24. The hearing aid device as claimed in claim 23, wherein the adjusting element makes a distinction between a plurality of movement patterns of the detected finger or the object and modifies assigned setting values of the hearing aid device in each instance.

25. The hearing aid device as claimed in claim 17, wherein the adjusting element detects the presence and/or position of an object or finger in the surroundings of the adjusting element by measuring the reflected signal of an emitted measuring signal.

26. The hearing aid device as claimed in claim 25, wherein the adjusting element makes a distinction between a plurality of movement patterns of the detected finger or the object and modifies assigned setting values of the hearing aid device in each instance.

27. The hearing aid device as claimed in claim 17, wherein the adjusting element detects the presence and/or position of an object or finger in the surroundings of the adjusting element by measuring a heat radiation.

28. The hearing aid device as claimed in claim 27, wherein the adjusting element makes a distinction between a plurality of movement patterns of the detected finger or the object and modifies assigned setting values of the hearing aid device in each instance.

29. The hearing aid device as claimed in claim 17, wherein the adjusting element forms an on/off switch.

30. The hearing aid device as claimed in claim 17, wherein the adjusting element forms a volume actuating element.

31. The hearing aid device as claimed in claim 17, wherein the adjusting element has a two-dimensional grid of electrodes.

32. The hearing aid device as claimed in claim 17, wherein the housing of the hearing aid device is to be worn by a user behind an ear.

33. The hearing aid device as claimed in claim 17, wherein the housing wherein the hearing aid device is water resistant.

34. The hearing aid device as claimed in claim 17, wherein the housing of the hearing aid device is watertight.
